(19) United States
(12) Patent Application Publication
(10) Pub. No.: US 2024/0012845 A1
(43) Pub. Date: Jan. 11, 2024

(54) COMPUTER-READABLE RECORDING MEDIUM STORING INFORMATION DETERMINATION PROGRAM, INFORMATION PROCESSING APPARATUS, AND INFORMATION DETERMINATION METHOD

(71) Applicant: Fujitsu Limited, Kawasaki-shi (JP)

(72) Inventors: Kaori FUJIMOTO, Kamakura (JP); Masayoshi SHIMIZU, Hadano (JP); Kentaro TSUJI, Kawasaki (JP)

(73) Assignee: Fujitsu Limited, Kawasaki-shi (JP)

(21) Appl. No.: 18/298,067

(22) Filed: Apr. 10, 2023

(30) Foreign Application Priority Data
Jul. 5, 2022 (JP) 2022-108443

(51) Int. Cl. G06F 16/35; G06F 40/205

(52) U.S. Cl. CPC G06F 16/35; G06F 40/205

(57) ABSTRACT

A non-transitory computer-readable recording medium stores an information determination program causing a computer to execute a process including: classifying a plurality of sentences posted on the Internet into a plurality of clusters based on words contained in the plurality of sentences; extracting a topic from each of the plurality of clusters, the topic indicating a feature of a plurality of sentences included in the concerned cluster; for each of the plurality of clusters, determining a likelihood that a sentence about the topic newly posted on the Internet will turn to disinformation or misinformation based on an occurrence state of sentences considered as a factor for generating disinformation or misinformation in the plurality of sentences included in the concerned cluster; and outputting the topic associated with a cluster, the likelihood of turning of which satisfies a predetermined condition, among the plurality of clusters.

### CROSS-REFERENCE TO RELATED APPLICATION

This application is based upon and claims the benefit of priority of the prior Japanese Patent Application No. 2022-108443, filed on Jul. 5, 2022, the entire contents of which are incorporated herein by reference.

### FIELD

The embodiments discussed herein are related to a computer-readable recording medium storing an information determination program, an information processing apparatus, and an information determination method.

### BACKGROUND

At the occurrence of a disaster such as a large earthquake (hereafter, also simply referred to as a disaster), for example, disinformation or misinformation is spread in some cases. The disinformation is false or incorrect information purposely spread, for example, whereas the misinformation is not information spread purposely but is information having wrong contents, for example.

Japanese Laid-open Patent Publication No. 2013-077155, International Publication Pamphlet Nos. WO 2013/073377 and 2013/179340, and U.S. Patent Application Publication Nos. 2019/0014071 and 2019/0179861 are disclosed as related art.

### SUMMARY

According to an aspect of the embodiments, a non-transitory computer-readable recording medium stores an information determination program causing a computer to execute a process including: classifying a plurality of sentences posted on the Internet into a plurality of clusters based on words contained in the plurality of sentences; extracting a topic from each of the plurality of clusters, the topic indicating a feature of a plurality of sentences included in the concerned cluster; for each of the plurality of clusters, determining a likelihood that a sentence about the topic newly posted on the Internet will turn to disinformation or misinformation based on an occurrence state of sentences considered as a factor for generating disinformation or misinformation in the plurality of sentences included in the concerned cluster; and outputting the topic associated with a cluster, the likelihood of turning of which satisfies a predetermined condition, among the plurality of clusters.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating a configuration of an information processing system;

FIG. 2 is a diagram for explaining a timing at which disinformation or misinformation is detected;

FIG. 3 is a diagram for explaining a timing at which disinformation or misinformation is detected;

FIG. 4 is a diagram illustrating a hardware configuration of an information processing apparatus;

FIG. 5 is a diagram illustrating functions of an information processing apparatus in a first embodiment;

FIG. 6 is a flowchart for explaining an outline of an information determination method in the first embodiment;

FIG. 7 is a diagram for explaining the outline of the information determination method in the first embodiment;

FIG. 8 is a diagram for explaining the outline of the information determination method in the first embodiment;

FIG. 9 is a flowchart for explaining details of the information determination method in the first embodiment;

FIG. 10 is a flowchart for explaining the details of the information determination method in the first embodiment;

FIG. 11 is a diagram for explaining the details of the information determination method in the first embodiment;

FIG. 12 is a diagram for explaining the details of the information determination method in the first embodiment;

FIG. 13 is a diagram for explaining the details of the information determination method in the first embodiment;

FIG. 14 is a diagram for explaining the details of the information determination method in the first embodiment;

FIG. 15 is a diagram for explaining the details of the information determination method in the first embodiment;

FIG. 16 is a diagram for explaining the details of the information determination method in the first embodiment;

FIG. 17 is a diagram for explaining functions of an information processing apparatus in a second embodiment;

FIG. 18 is a flowchart for explaining details of an information determination method in the second embodiment;

FIG. 19 is a flowchart for explaining the details of the information determination method in the second embodiment; and

FIG. 20 is a diagram for explaining the details of the information determination method in the second embodiment.

### DESCRIPTION OF EMBODIMENTS

To address this, in a case where a disaster occurs, various methods for checking the authenticity of information spread on the Internet are used from the viewpoint of, for example, restriction of the spread of disinformation or misinformation.

In a case where a disaster as described above occurs, disaster victims feel strong frustration and therefore tend to be intensely preoccupied and become more suspicious. For this reason, when a disaster occurs, for example, disinformation or misinformation is spread on the Internet at very high speed, which may cause further confusion.

Hence, in an aspect, an object of the present disclosure is to provide a computer-readable recording medium storing an information determination program, an information processing apparatus, and an information determination method that enable restriction of the spread of disinformation or misinformation.

[Configuration of Information Processing System in First Embodiment]

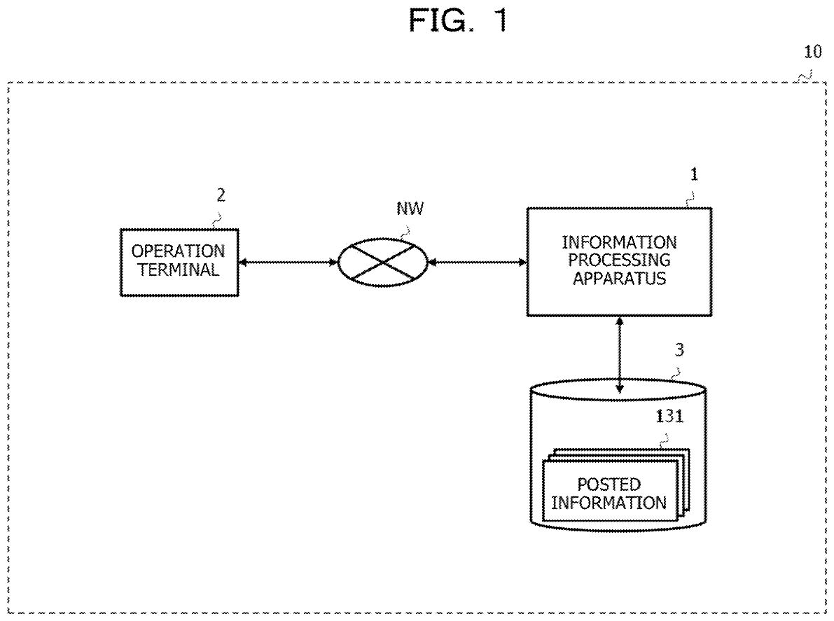

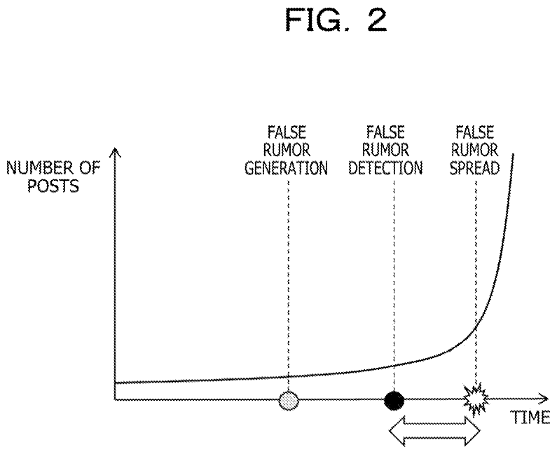

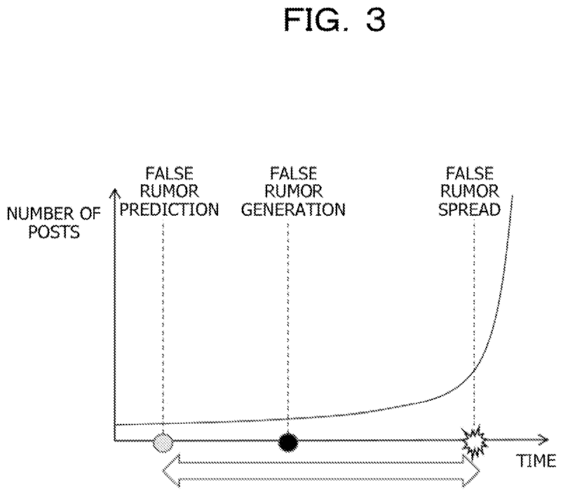

First, a configuration of an information processing system 10 will be described. FIG. 1 is a diagram illustrating a configuration of the information processing system 10. FIGS. 2 and 3 are diagrams for explaining a timing at which disinformation or misinformation is detected.

The information processing system 10 illustrated in FIG. 1 includes, for example, an information processing apparatus 1, an operation terminal 2, and a storage device 3.

For example, the storage device 3 is a hard disk drive (HDD) or a solid-state drive (SSD), and stores posted information 131 containing multiple sentences posted on the Internet. The storage device 3 may be arranged outside the information processing apparatus 1 or may be arranged inside the information processing apparatus 1.

For example, the operation terminal 2 is a personal computer (PC) or the like through which an operator inputs desired information to the information processing apparatus 1. For example, the operation terminal 2 is a terminal capable of accessing the information processing apparatus 1 via a network NW such as the Internet.

The information processing apparatus 1 is, for example, a physical machine or a virtual machine, and performs processing of determining a possibility of occurrence of disinformation or misinformation (hereafter, these kinds of information will be collectively referred to as a “false rumor”) (hereafter, the processing will be also referred to as information determination processing).

For example, the information processing apparatus 1 refers to the posted information 131 stored in the storage device 3, and determines whether or not the posted information 131 contains a sentence likely to turn to disinformation or misinformation.

For example, the information processing apparatus 1 classifies the multiple sentences contained in the posted information 131 stored in the storage device 3 (multiple sentences posted on the Internet) into multiple clusters based on words contained in the multiple sentences in the posted information 131 stored in the storage device 3. For example, the information processing apparatus 1 extracts a topic from each of the multiple clusters, the topic composed of one or more words indicating a feature of the multiple sentences included in the concerned cluster.

Subsequently, for example, the information processing apparatus 1 determines a likelihood of turning to disinformation or misinformation for each of the multiple clusters based on the occurrence state of sentences considered as a factor for generating disinformation or misinformation (hereafter, such sentences will be also referred to as specific sentences) in the multiple sentences included in the concerned cluster. The likelihood of turning to disinformation or misinformation means a likelihood that a sentence about the topic (the topic associated with the concerned cluster) newly posted on the Internet will turn to disinformation or misinformation.

After that, for example, the information processing apparatus 1 outputs the topic associated with the cluster whose likelihood of turning satisfies a predetermined condition among the multiple clusters.

For example, in a case where whether or not disinformation or misinformation is generated is determined by checking the authenticity of sentences already posted on the Internet, the timing at which the disinformation or misinformation is detected is, for example, a timing after the disinformation or misinformation is generated as illustrated in FIG. 2. For this reason, in a case where the speed of the spread of disinformation or misinformation is high, for example, as in the case of a disaster occurrence, an operator sometimes has difficulty in effectively coping with the spread of the disinformation or misinformation due to a failure to secure enough time to cope with the spread.

To address this, the information processing apparatus 1 in the present embodiment makes a prediction about a likelihood that a sentence posted on the Internet will turn to disinformation or misinformation at a stage before disinformation or misinformation is generated on the Internet, for example.

Thus, the information processing apparatus 1 in the present embodiment is able to predict the generation of disinformation or misinformation at the stage before the disinformation or misinformation is generated, for example, as illustrated in FIG. 3. Therefore, for example, even in a case where the speed of the spread of disinformation or misinformation is high, the information processing apparatus 1 makes it possible to secure enough time to cope with the spread of the disinformation or misinformation. Accordingly, for example, even in a case where the speed of the spread of disinformation or misinformation is high, the operator is enabled to effectively cope with the spread of the disinformation or misinformation.

[Hardware Configuration of Information Processing Apparatus]

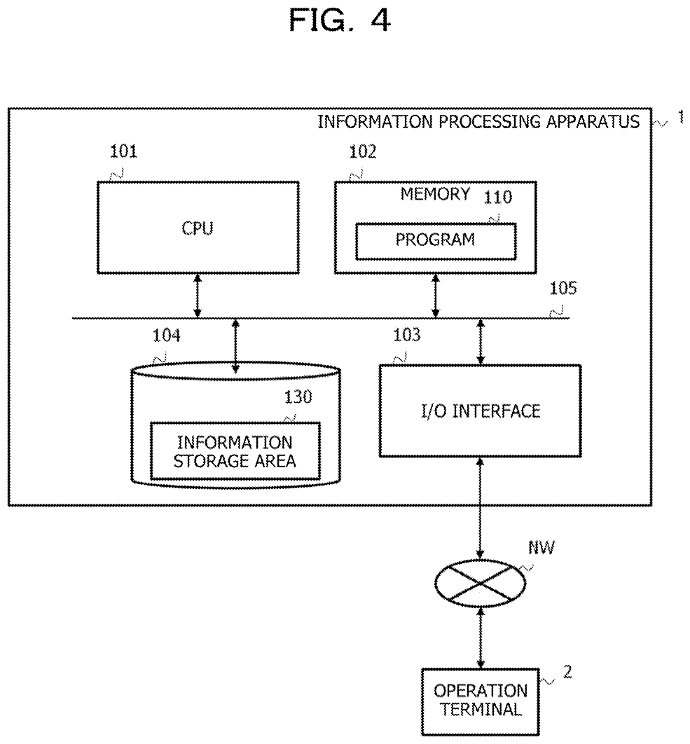

Next, a hardware configuration of the information processing apparatus 1 will be described. FIG. 4 is a diagram illustrating the hardware configuration of the information processing apparatus 1.

As illustrated in FIG. 4, the information processing apparatus 1 includes a central processing unit (CPU) 101, which is, for example, a processor, a memory 102, a communication device (input/output (I/O) interface) 103, and a storage 104. These components are coupled to one another via a bus 105.

For example, the storage 104 includes a program storage area (not illustrated) for storing a program 110 for performing the information determination processing. For example, the storage 104 includes an information storage area 130 that stores information used when the information determination processing is performed. For example, the storage 104 may be an HDD or an SSD.

For example, the CPU 101 executes the program 110 loaded on the memory 102 from the storage 104 to perform the information determination processing.

The communication device 103 performs communication with the operation terminal 2 via the network NW, for example.

[Functions of Information Processing Apparatus in First Embodiment]

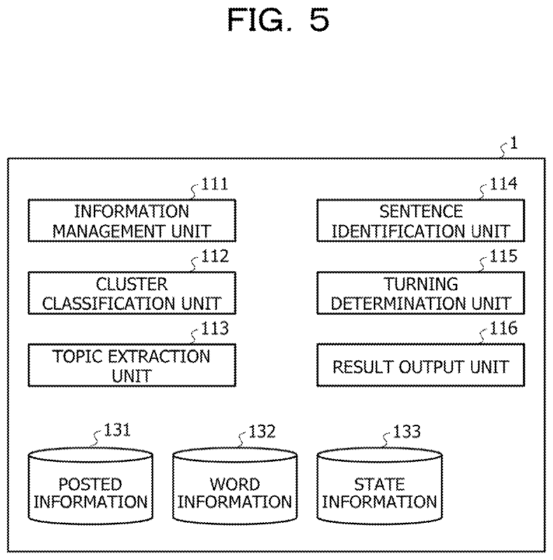

Next, functions of the information processing apparatus 1 in the first embodiment will be described. FIG. 5 is a diagram for explaining the functions of the information processing apparatus 1 in the first embodiment.

In the information processing apparatus 1, for example, hardware such as the CPU 101 and the memory 102 and the program 110 organically cooperate with each other to implement various functions including an information management unit 111, a cluster classification unit 112, a topic extraction unit 113, a sentence identification unit 114, a turning determination unit 115, and a result output unit 116 as illustrated in FIG. 5.

In the information processing apparatus 1, for example, the posted information 131, word information 132, and state information 133 are stored in the information storage area 130 as illustrated in FIG. 5.

For example, the information management unit 111 acquires the posted information 131 stored in the storage device 3 and stores the acquired posted information 131 in the information storage area 130. Although a case where the information management unit 111 acquires the posted information 131 stored in the storage device 3 will be described below, the information management unit 111 may automatically acquire, for example, sentences posted on the Internet (for example, sentences related to a disaster that just occurred) and store the acquired sentences as the posted information 131 in the information storage area 130.

For example, the cluster classification unit 112 classifies multiple sentences contained in the posted information 131 into multiple clusters based on words contained in the multiple sentences contained in the posted information 131 stored in the information storage area 130.

For example, the cluster classification unit 112 calculates a similarity between words contained in the multiple sentences contained in the posted information 131. For example, the cluster classification unit 112 classifies the multiple sentences contained in the posted information 131 into the multiple clusters such that sentences having a high similarity are classified into the same cluster.

For example, the topic extraction unit 113 extracts a topic from each of the multiple clusters classified by the cluster classification unit 112, the topic composed of one or more words indicating a feature of multiple sentences included in the concerned cluster.

For example, for each of the multiple clusters classified by the cluster classification unit 112, the sentence identification unit 114 identifies specific sentences as a factor for generating disinformation or misinformation among the multiple sentences included in the concerned cluster.

For example, as a specific sentence for each of the multiple clusters classified by the cluster classification unit 112, the sentence identification unit 114 identifies a sentence containing a word (hereafter, also referred to as a specific word) whose expression ambiguity satisfies a condition (hereafter, also referred to as a first condition) among the multiple sentences included in the concerned cluster.

For example, as a specific sentence for each of the multiple clusters classified by the cluster classification unit 112, the sentence identification unit 114 identifies a sentence whose creator's mental state in creating the sentence satisfies a condition (hereafter, also referred to as a second condition) among the multiple sentences included in the concerned cluster.

For example, when having highly anxious emotion during a disaster or the like, a disaster victim tends to be unable to calmly judge whether hearsay information is authentic or not. For this reason, for example, it is possible to determine that there is a high likelihood that a sentence containing an ambiguous expression or a sentence whose creator's emotion in creating the sentence is determined as a negative emotion will turn to disinformation or misinformation.

For this reason, for example, as a specific sentence for each of the multiple clusters, the sentence identification unit 114 identifies a sentence containing an ambiguous expression or a sentence whose creator's emotion is determined as a negative emotion among the multiple sentences included in the concerned cluster.

For example, for each of the multiple clusters classified by the cluster classification unit 112, the turning determination unit 115 determines a likelihood that a new sentence newly posted on the Internet will turn to disinformation or misinformation based on the occurrence state of the specific sentence in the multiple sentences included in the concerned cluster.

For example, the turning determination unit 115 generates multiple pieces of teacher data each containing, for example, a value indicating an occurrence state of a specific sentences in multiple sentences for learning (hereafter, also referred to as multiple other sentences) and a value indicating a likelihood that a new sentence newly posted on the Internet will turn to disinformation or misinformation. For example, the multiple sentences for learning may be multiple sentences which are posted on the Internet and which are other than the sentences contained in the posted information 131. For example, the turning determination unit 115 generates a learning model (not illustrated) in advance by learning the multiple pieces of teacher data. After that, for example, for each of the multiple clusters classified by the cluster classification unit 112, the turning determination unit 115 acquires a value output from the learning model in response to input of the value indicating the occurrence state of the specific sentences in the multiple sentences included in the concerned cluster, as a value indicating a likelihood that a new sentence newly posted on the Internet will turn to disinformation or misinformation.

For example, the result output unit 116 outputs the topic associated with a cluster whose likelihood of turning determined by the turning determination unit 115 satisfies the predetermined condition among the multiple clusters classified by the cluster classification unit 112.

For example, the result output unit 116 outputs the topic associated with the cluster for which the value acquired by the turning determination unit 115 is equal to or greater than a predetermined threshold among the multiple clusters classified by the cluster classification unit 112. The word information 132 and the state information 133 will be described later.

[Outline of Information Determination Processing in First Embodiment]

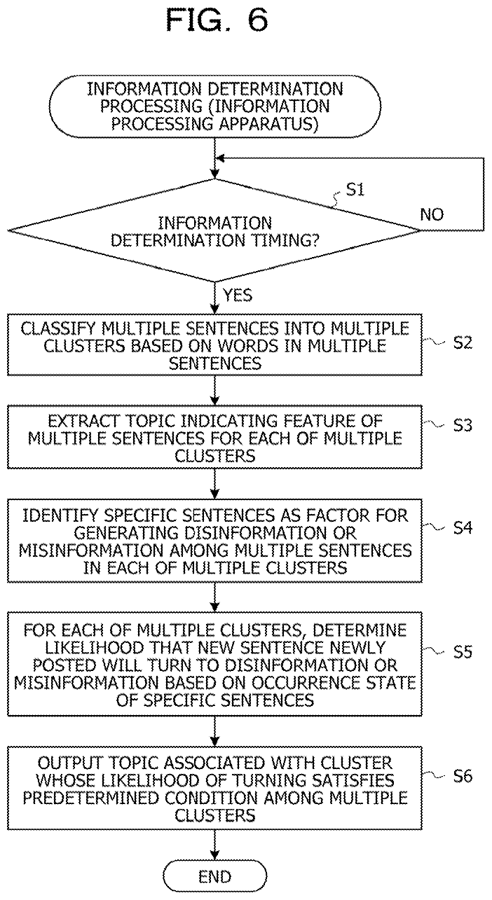

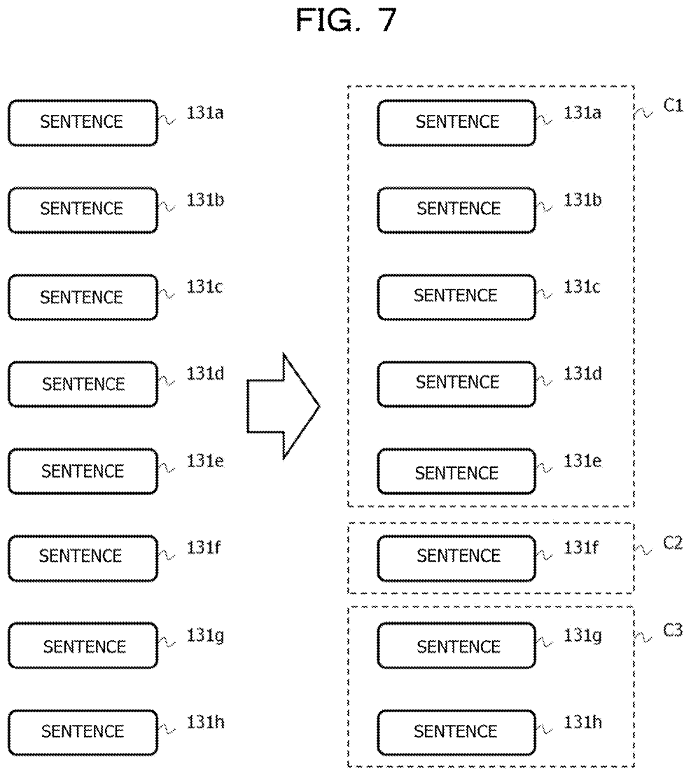

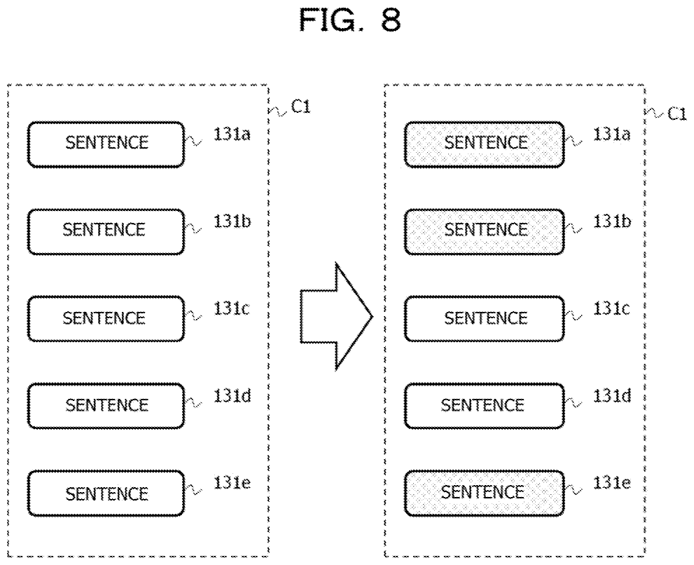

Next, an outline of the first embodiment will be described. FIG. 6 is a flowchart for explaining an outline of information determination processing in the first embodiment. FIGS. 7 and 8 are diagrams for explaining the outline of information determination processing in the first embodiment.

As presented in FIG. 6, the information processing apparatus 1 waits until, for example, an information determination timing comes (NO in S1). For example, the information determination timing may be, for example, a timing at which an operator inputs information instructing the start of the information determination processing via the operation terminal 2. The information determination timing may be, for example, a periodic timing such as every 10 minutes.

When the information determination timing comes (YES in S1), the information processing apparatus 1 classifies multiple sentences posted on the Internet into multiple clusters based on words contained in the multiple sentences posted on the Internet (S2), for example.

For example, the information processing apparatus 1 (the cluster classification unit 112) extracts words contained in each of the multiple sentences posted on the Internet (the multiple sentences contained in the posted information 131 stored in the information storage area 130). By using a method such for example as a Latent Dirichlet Allocation (LDA) topic model or Word2vec, the information processing apparatus 1 (the cluster classification unit 112) classifies the multiple sentences contained in the posted information 131 into multiple clusters such that sentences determined to have a high word similarity are classified into the same cluster.

For example, when the information processing apparatus 1 determines that there is a high similarity among words contained in respective sentences 131a, 131b, 131c, 131d, and 131e among the multiple sentences contained in the posted information 131 stored in the information storage area 130, the information processing apparatus 1 sorts the sentences 131a, 131b, 131c, 131d, and 131e into the same cluster C1 as illustrated in FIG. 7.

For example, when the information processing apparatus 1 determines that there is a high similarity between words contained in respective sentences 131g and 131h among the multiple sentences contained in the posted information 131 stored in the information storage area 130, the information processing apparatus 1 sorts the sentences 131g and 131h into the same cluster C3.

On the other hand, for example, when the information processing apparatus 1 determines that none of the multiple sentences contained in the posted information 131 stored in the information storage area 130 has a high similarity to any word contained in a sentence 131f, the information processing apparatus 1 sorts only the sentence 131f into a cluster C2.

For example, from each of the multiple clusters, the information processing apparatus 1 extracts a topic composed of one or more words indicating a feature of the multiple sentences included in the concerned cluster (S3).

For example, when using the LDA topic model in the processing at S2, the information processing apparatus 1 (the topic extraction unit 113) extracts, as a topic associated with each of the multiple clusters, a combination of one or more words having a high probability of being contained in each of the multiple sentences included in the concerned cluster.

For example, when using Word2vec in the processing at S2, the information processing apparatus 1 (the topic extraction unit 113) extracts, as a topic associated with each of the multiple clusters, a combination of one or more words having a distributed representation close to the center of gravity among the words contained in the multiple sentences included in the concerned cluster.

Subsequently, for example, for each of the multiple clusters, the information processing apparatus 1 identifies specific sentences as a factor for generating disinformation or misinformation among the multiple sentences included in the concerned cluster (S4).

For example, as the specific sentences for each of the multiple clusters, the information processing apparatus 1 (sentence identification unit 114) identifies a sentence containing an ambiguous expression and a sentence whose creator's emotion is determined as a negative emotion such as anxiety among the multiple sentences included in the concerned cluster.

For example, when the sentences 131a, 131b, and 131e are sentences each containing an ambiguous expression among the sentences 131a, 131b, 131c, 131d, and 131e (the sentences classified into the cluster C1), the information processing apparatus 1 identifies the sentences 131a, 131b, and 131e as the specific sentences (shaded sentences in FIG. 8) as illustrated in FIG. 8.

For example, for each of the multiple clusters, the information processing apparatus 1 determines a likelihood that a new sentence newly posted on the Internet will turn to disinformation or misinformation based on the occurrence state of the specific sentences in the multiple sentences included in the concerned cluster (S5).

For example, for each of the multiple clusters, the information processing apparatus 1 (the turning determination unit 115) acquires the value output from the learning model (not illustrated) in response to input of the value indicating the occurrence state of the specific sentences in the multiple sentences included in the concerned cluster, as the value indicating the likelihood that a new sentence newly posted on the Internet will turn to disinformation or misinformation.

The value indicating the occurrence state of the specific sentences in the multiple sentences included in each cluster may be, for example, the number of occurrences per unit time of the specific sentences in the multiple sentences included in the concerned cluster or an occurrence ratio per unit time of the specific sentences in the multiple sentences included in the concerned cluster.

After that, for example, the information processing apparatus 1 outputs a topic associated with a cluster whose likelihood of turning satisfies the predetermined condition among the multiple clusters (S6).

For example, the information processing apparatus 1 (the result output unit 116) outputs the topic associated with the cluster for which the value acquired in the processing at S5 is equal to or greater than the threshold among the multiple clusters classified in the processing at S2.

In this way, the information processing apparatus 1 in the present embodiment is able to predict the generation of disinformation or misinformation at a stage before the disinformation or misinformation is generated, for example. Therefore, for example, even in a case where the speed of the spread of disinformation or misinformation is high, the information processing apparatus 1 makes it possible to secure enough time to cope with the spread of the disinformation or misinformation. Accordingly, for example, even in a case where the speed of the spread of disinformation or misinformation is high, the operator is enabled to effectively cope with the spread of the disinformation or misinformation.

For example, the information processing apparatus 1 in the present embodiment determines, for each cluster, a likelihood that a new sentence newly posted on the Internet will turn to disinformation or misinformation, thereby making it possible to reduce the volume of sentences determined to have a likelihood of turning to disinformation or misinformation among sentences newly posted on the Internet. Therefore, for example, the information processing apparatus 1 makes it possible to reduce a burden for coping with the spread of disinformation or misinformation (for example, a work burden on an operator).

For example, the information processing apparatus 1 in the present embodiment outputs a topic associated with a cluster whose likelihood of turning satisfies the predetermined condition, and thereby makes it possible to adopt a method suitable for restriction of the spread of disinformation or misinformation associated with the output topic and to effectively restrict the spread of disinformation or misinformation.

[Details of Information Determination Processing in First Embodiment]

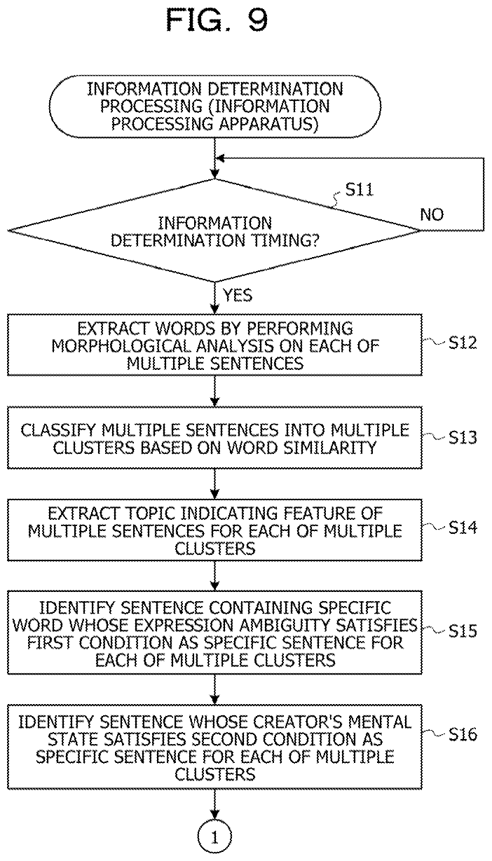

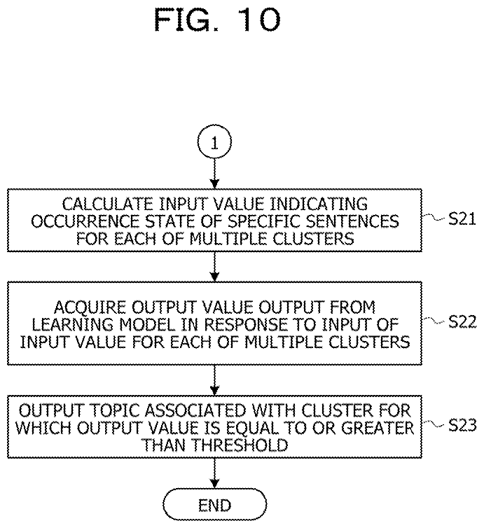

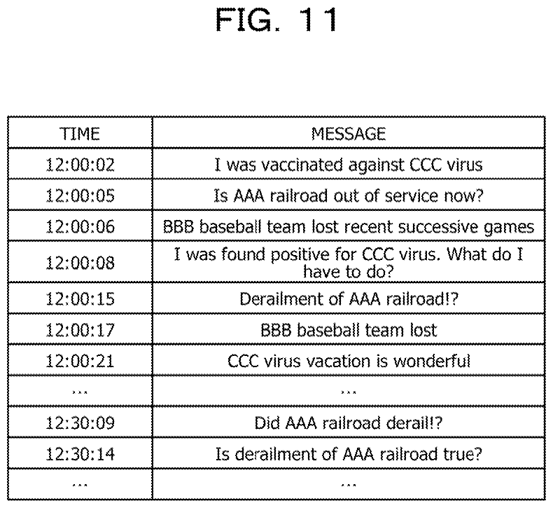

Next, details of the first embodiment will be described. FIGS. 9 and 10 are flowcharts for explaining the details of the information determination processing in the first embodiment. FIGS. 11 to 16 are diagrams for explaining the details of the information determination processing in the first embodiment.

As presented in FIG. 9, the cluster classification unit 112 waits until, for example, an information determination timing comes (NO in S11).

When the information determination timing comes (YES in S11), the cluster classification unit 112 performs morphological analysis on each of multiple sentences contained in the posted information 131 stored in the information storage area 130, and thereby extracts words from each of the sentences (S12), for example. Hereinafter, a specific example of the posted information 131 will be described.

[Specific Example of Posted Information]

FIG. 11 is a diagram for explaining a specific example of the posted information 131.

For example, the posted information 131 presented in FIG. 11 includes items named “Time” in which a time when each sentence was posted on the Internet is set, and “Message” in which a content in each sentence posted on the Internet is set.

For example, in the first line of the posted information 131 presented in FIG. 11, “12:00:02” is set as “Time” and “I was vaccinated against CCC virus” is set as “Message”.

For example, in the second line of the posted information 131 presented in FIG. 11, “12:00:05” is set as “Time” and “Is AAA railroad out of service now?” is set as “Message”.

For example, in the third line of the posted information 131 presented in FIG. 11, “12:00:06” is set as “Time” and “BBB baseball team lost recent successive games” is set as “Message”.

For example, in the fourth line of the posted information 131 presented in FIG. 11, “12:00:08” is set as “Time” and “I was found positive for CCC virus. What do I have to do?” is set as “Message”. Description for the remaining information contained in FIG. 11 is omitted herein.

The sentences specified in the posted information 131 stored in the information storage area 130 may be, for example, sentences posted within a predetermined period (for example, one hour) on one or more social networking services (SNS) designated in advance.

Returning to FIG. 9, for example, the cluster classification unit 112 classifies each of the multiple sentences contained in the posted information 131 stored in the information storage area 130 into one of multiple clusters such that sentences having a high similarity between words extracted in the processing at S12 are sorted into the same cluster (S13). Hereinafter, a specific example of the processing at S13 will be described.

[Specific Example of Processing at S13]

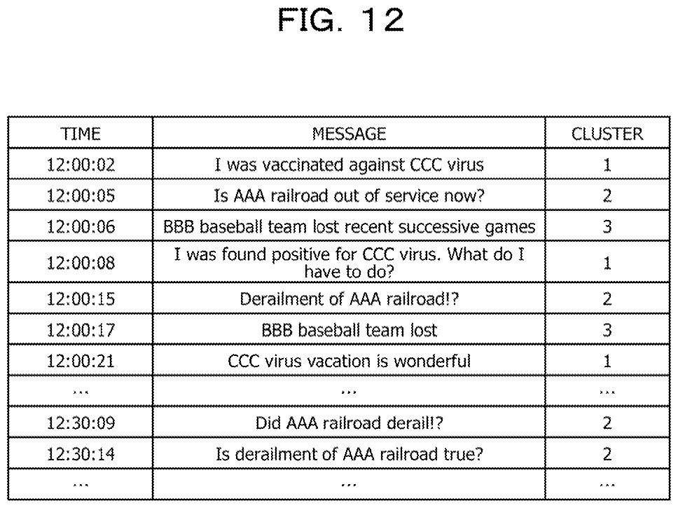

FIG. 12 is a diagram for explaining a specific example of the processing at S13. For example, FIG. 12 is the diagram for explaining a specific example of information indicating a classification result of the multiple sentences (hereafter, also referred to as cluster information 1311) in the processing at S13.

For example, the cluster information 1311 presented in FIG. 12 includes an item named “Cluster” specifying a cluster into which each sentence is classified in addition to the items contained in the posted information 131 presented in FIG. 11.

For example, in the first line of the cluster information 1311 presented in FIG. 12, “1” specifying a first cluster is set as “Cluster” in addition to the information in the first line in the posted information 131 presented in FIG. 11.

In the second line of the cluster information 1311 presented in FIG. 12, “2” specifying a second cluster is set as “Cluster” in addition to the information in the second line in the posted information 131 presented in FIG.

In the third line of the cluster information 1311 presented in FIG. 12, “3” specifying a first cluster is set as “Cluster” in addition to the information in the third line in the posted information 131 presented in FIG. 11. Description for the remaining information contained in FIG. 12 is omitted herein.

For example, as presented in FIG. 12, the cluster classification unit 112 determines that multiple sentences commonly containing “CCC virus” or a word related to “CCC virus” have a high similarity in the sentences contained in the posted information 131 presented in FIG. 11, and classifies the multiple sentences into the same cluster. In the same manner, the cluster classification unit 112 determines that multiple sentences commonly containing, for example, “AAA railroad” or a word related to “MA railroad” have a high similarity in the sentences contained in the posted information 131 presented in FIG. 11, and classifies the multiple sentences into the same cluster. The cluster classification unit 112 determines that multiple sentences commonly containing, for example, “BBB baseball team” or a word related to “BBB baseball team” have a high similarity in the sentences contained in the posted information 131 presented in FIG. 11, and classifies the multiple sentences into the same cluster.

Returning to FIG. 9, for example, from each of the multiple clusters classified in the processing at S13, the topic extraction unit 113 extracts a topic composed of one or more words indicating a feature of the multiple sentences included in the concerned cluster (S14). Hereinafter, a specific example of the processing at S14 will be described.

[Specific Example of Processing at S14]

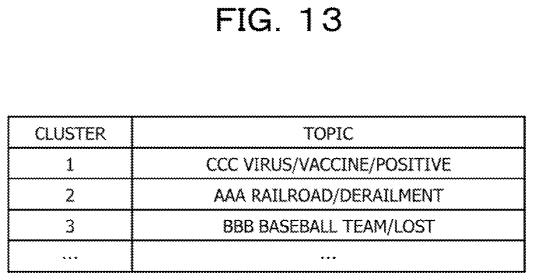

FIG. 13 is a diagram for explaining a specific example of the processing at S14. For example, FIG. 13 is the diagram for explaining a specific example of information indicating a topic extraction result (hereafter, also referred to as topic information 1312) in the processing at S14.

For example, the topic information 1312 presented in FIG. 13 includes items named “Cluster” specifying a cluster into which each sentence is classified and “Topic” in which a topic associated with each cluster is set.

For example, in the first line of the topic information 1312 presented in FIG. 13, “1” is set as “Cluster”, and “CCC virus”, “vaccine”, and “positive” are set as “Topic”.

In the second line of the topic information 1312 presented in FIG. 13, “2” is set as “Cluster”, and “AAA railroad” and “derail” are set as “Topic”.

In the third line of the topic information 1312 presented in FIG. 13, “3” is set as “Cluster”, and “BBB baseball team” and “lost” are set as “Topic”.

Returning to FIG. 9, for example, as a specific sentence for each of the multiple clusters classified in the processing at S13, the sentence identification unit 114 identifies a sentence containing a specific word whose expression ambiguity satisfies the first condition among the multiple sentences included in the concerned cluster (S15).

For example, the sentence identification unit 114 refers to the information storage area 130 in which the word information 132 specifying specific words is stored, and determines whether or not each of the multiple sentences included in each of the multiple clusters classified in the processing at S13 contains any of the specific words. For example, the word information 132 is information specifying ambiguous words designated in advance. For example, as at least part of a specific sentence for each of the multiple clusters classified in the processing at S13, the sentence identification unit 114 identifies a sentence containing any of the specific words among the multiple sentences included in the concerned cluster.

For example, the specific sentence is a sentence containing at least any one of the words contained in the word information 132 stored in the information storage area 130. Hereinafter, a specific example of the word information 132 will be described.

[Specific Example of Word Information]

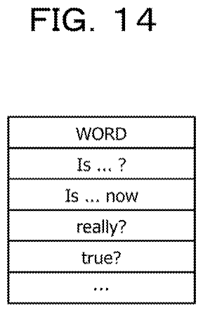

FIG. 14 is a diagram for explaining a specific example of the word information 132.

For example, the word information 132 presented in FIG. 14 includes an item named “Word” in which a word designated as an ambiguous word in advance is set.

For example, in the word information 132 presented in FIG. 14, “Is . . . ?” is set as “Word” in the first line and “Is . . . now?” is set as “Word” in the second line. Description for the remaining information contained in FIG. 14 is omitted herein.

For example, in the second line of the cluster information 1311 described with reference to FIG. 12, “Is AAA railroad out of service now?” is set as “Message”. For example, in the second line of the cluster information 1311 described with reference to FIG. 12, the sentence containing “Is . . . now?” is set as “Message”. For this reason, in the processing at S15, the sentence identification unit 114 identifies, as a specific sentence, for example, the sentence set in the second line of the cluster information 1311 described with reference to FIG. 12.

Returning to FIG. 9, for example, the sentence identification unit 114 identifies, as a specific sentence for each of the multiple clusters classified in the processing at S13, a sentence whose creator's mental state satisfies the second condition among the multiple sentences included in the concerned cluster (S16).

For example, the sentence identification unit 114 refers to the information storage area 130 in which the state information 133 specifying mental states of creators of sentences (the mental states in creating the sentences) is stored, and determines whether or not the mental state of the creator of each of the multiple sentences (the mental state in creating the concerned sentence) in each of the multiple clusters classified in the processing at S13 is contained in the state information 133. For example, the state information 133 is information specifying negative emotions such as anxiety. For example, as at least part of a specific sentence for each of the multiple clusters classified in the processing at S13, the sentence identification unit 114 identifies a sentence whose creator's mental state is determined to be contained in the state information 133 among the multiple sentences included in the concerned cluster.

For example, the specific sentence is a sentence whose creator's mental state (the mental state in creating the sentence) is at least any of the emotions contained in the state information 133 stored in the information storage area 130. Hereinafter, a specific example of the state information 133 will be described.

[Specific Example of State Information]

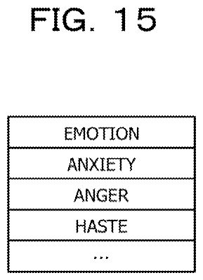

FIG. 15 is a diagram for explaining a specific example of the state information 133.

For example, the state information 133 presented in FIG. 15 includes an item named “Emotion” in which each emotion designated in advance as a negative emotion is set.

For example, in the state information 133 presented in FIG. 15, “Anxiety” is set as “Emotion” in the first line, and “Anger” is set as “Emotion” in the second line. Description for the remaining information contained in FIG. 15 is omitted herein.

For example, in the fourth line of the cluster information 1311 described with reference to FIG. 12, “I was found positive for CCC virus. What do I have to do?” is set as “Message”. For example, in the fourth line of the cluster information 1311 described with reference to FIG. 12, it is determined that the sentence containing a word “What do I have to do?” indicating an anxious emotion is set as “Message”. For this reason, in processing at S16, the sentence identification unit 114 determines that the creator felt anxious when creating the sentence set in the fourth line of the cluster information 1311 described with reference to FIG. 12, and identifies, as a specific sentence, the sentence set in the fourth line of the cluster information 1311 described with reference to FIG. 12, for example.

For example, in the processing at S16, the sentence identification unit 114 may extract an emotion associated with each of the sentences contained in the cluster information 1311 by using a method such as an emotive element and expression analysis system (ML-Ask). For example, the sentence identification unit 114 may identifies specific sentences by using the extracted emotions.

Returning to FIG. 10, for example, for each of the multiple clusters classified in the processing at S13, the turning determination unit 115 calculates a value indicating an occurrence state of the specific sentences (hereafter, also referred to as an input value) in the multiple sentences included in the concerned cluster (S21).

For example, the turning determination unit 115 may calculate the number of occurrences per unit time (for example, per hour) of the specific sentences for each of the multiple clusters classified in the processing at S13. For example, the turning determination unit 115 may calculate the sum of the number of occurrences per unit time of the specific sentences identified in the processing at S15 and the number of occurrences per unit time of the specific sentences identified in the processing at S16. For example, the turning determination unit 115 may calculate an increase or decrease rate of the number of occurrences per unit time of the specific sentences for each of the multiple clusters classified in the processing at S13. For example, the turning determination unit 115 may calculate the occurrence ratio per unit time of the specific sentences for each of the multiple clusters classified in the processing at S13. For example, the turning determination unit 115 may calculate an increase or decrease rate in the occurrence ratio per unit time of the specific sentences for each of the multiple clusters classified in the processing at S13.

For example, the turning determination unit 115 acquires a value output from the learning model (hereafter, also referred to as an output value) in response to input of the value calculated in the processing at S21 for each of the multiple clusters classified in the processing at S13 (S22).

After that, the result output unit 116 outputs, for example, a topic associated with a cluster for which the value acquired in the processing at S22 is equal to or greater than a predetermined threshold among the multiple clusters classified in the processing at S13 (S23).

As described above, for example, the information processing apparatus 1 in the present embodiment classifies multiple sentences posted on the Internet into multiple clusters based on words contained in the multiple sentences posted on the Internet. For example, the information processing apparatus 1 extracts a topic from each of the multiple clusters, the topic composed of one or more words indicating a feature of the multiple sentences included in the concerned cluster.

Subsequently, for example, for each of the multiple clusters, the information processing apparatus 1 identifies specific sentences as a factor for generating disinformation or misinformation among the multiple sentences included in the concerned cluster. For example, for each of the multiple clusters, the information processing apparatus 1 determines the likelihood that a new sentence newly posted on the Internet will turn to disinformation or misinformation based on the occurrence state of the specific sentences in the multiple sentences included in the concerned cluster.

After that, for example, the information processing apparatus 1 outputs the topic associated with the cluster whose likelihood of turning satisfies the predetermined condition among the multiple clusters.

For example, in a case where whether or not disinformation or misinformation is generated is determined by checking the authenticity of sentences already posted on the Internet, the timing at which the disinformation or misinformation is detected is, for example, a timing after the disinformation or misinformation is generated. For this reason, in a case where the speed of the spread of disinformation or misinformation is high, for example, as in the case of a disaster occurrence, an operator sometimes has difficulty in effectively coping with the spread of the disinformation or misinformation due to a failure to secure enough time to cope with the spread.

To address this, the information processing apparatus 1 in the present embodiment makes a prediction about a likelihood that a sentence posted on the Internet will turn to disinformation or misinformation at a stage before disinformation or misinformation is generated on the Internet, for example.

In this way, the information processing apparatus 1 in the present embodiment is able to predict the generation of disinformation or misinformation at a stage before the disinformation or misinformation is generated, for example. Therefore, for example, even in a case where the speed of the spread of disinformation or misinformation is high, the information processing apparatus 1 makes it possible to secure enough time to cope with the spread of the disinformation or misinformation. Accordingly, for example, even in a case where the speed of the spread of disinformation or misinformation is high, the operator is enabled to effectively cope with the spread of the disinformation or misinformation.

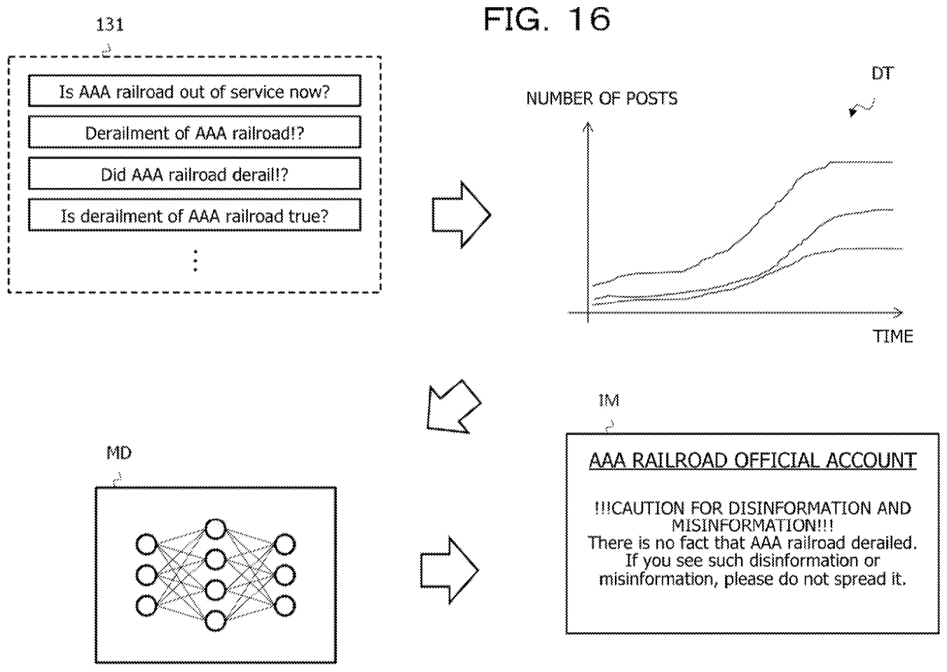

For example, as illustrated in FIG. 16, for each of the multiple clusters, the information processing apparatus 1 in the present embodiment acquires time-series data DT (see the upper right side in FIG. 16) indicating the number of posts of specific sentences among the multiple sentences (see the upper left side in FIG. 16) contained in the posted information 131 and classified into the concerned cluster. For example, for each of the multiple clusters, the information processing apparatus 1 inputs the value (for example, the latest number of posts per unit time) contained in the time-series data DT to the learning model MD (see the lower left side in FIG. 16) and acquires the value output from the learning model MD. After that, for example, the information processing apparatus 1 identifies the topic associated with a cluster for which the value output from the learning model MD is equal to or greater than the predetermined threshold among the multiple clusters.

Accordingly, for example, the operator is enabled to make public announcement of information IM or the like (see the lower right side in FIG. 16) as a countermeasure to restrict the spread of disinformation or misinformation related to the topic identified by the information processing apparatus 1.

For example, the information processing apparatus 1 (the turning determination unit 115) may generate multiple learning models in advance. For example, the information processing apparatus 1 (the turning determination unit 115) may use a learning model suited to a season when a disaster occurred, a place where the disaster occurred, or the like in the processing at S22.

[Outline of Information Determination Processing in Second Embodiment]

Next, an outline of information determination processing in a second embodiment will be described.

In the information determination processing in the second embodiment, a topic likely to turn to disinformation or misinformation is predicted by individually using an occurrence state of specific sentences each containing a specific word whose expression ambiguity satisfies the first condition (hereafter, also referred to as specific sentences meeting the first condition) and an occurrence state of specific sentences whose creator's mental states satisfy the second condition (hereafter, also referred to as specific sentences meeting the second condition) unlike the information determination processing in the first embodiment.

Thus, the information processing apparatus 1 is able to further improve the accuracy of prediction of a topic likely to turn to disinformation or misinformation, for example.

[Functions of Information Processing Apparatus in Second Embodiment]

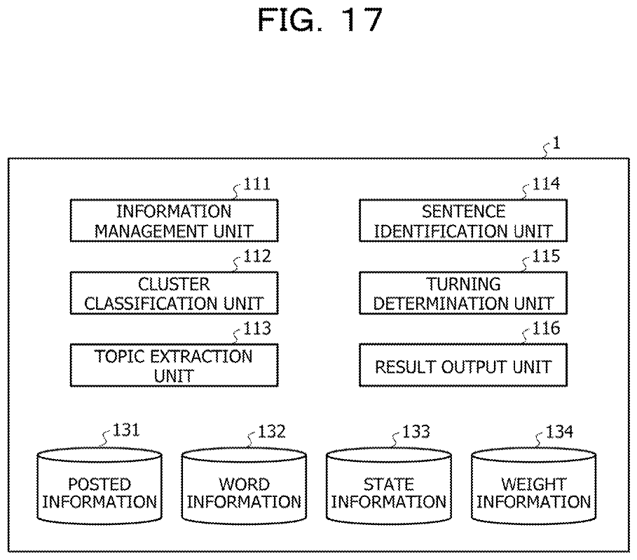

Next, functions of an information processing apparatus 1 in the second embodiment will be described. FIG. 17 is a diagram for explaining the functions of the information processing apparatus 1 in the second embodiment. Only differences from the first embodiment will be described below.

In the information processing apparatus 1, for example, hardware such as the CPU 101 and the memory 102 and the program 110 organically cooperate with each other to implement various functions including an information management unit 111, a cluster classification unit 112, a topic extraction unit 113, a sentence identification unit 114, a turning determination unit 115, and a result output unit 116 as illustrated in FIG. 17, as in the case of the first embodiment.

For example, as illustrated in FIG. 17, the information processing apparatus 1 stores weight information 134 in the information storage area 130 in addition to the posted information 131, the word information 132, and the state information 133.

For example, for each of the multiple clusters classified by the cluster classification unit 112, the turning determination unit 115 determines a likelihood that a new sentence newly posted on the Internet will turn to disinformation or misinformation based on both of the occurrence state of specific sentences meeting the first condition in the multiple sentences and the occurrence state of specific sentences meeting the second condition in the multiple sentences.

For example, the turning determination unit 115 generates a first learning model (not illustrated) in advance by learning multiple pieces of teacher data each containing a value indicating an occurrence state of specific sentences meeting the first condition in multiple sentences for learning and a value indicating a likelihood that a new sentence newly posted on the Internet will turn to disinformation or misinformation. For example, for each of the multiple clusters classified by the cluster classification unit 112, the turning determination unit 115 acquires a value (hereafter, also referred to as a second value) output from the first learning model in response to input of a value (hereafter, also referred to as a first value) indicating the occurrence state of specific sentences meeting the first condition in the multiple sentences, as a value indicating a likelihood that a new sentence newly posted on the Internet will turn to disinformation or misinformation.

For example, the turning determination unit 115 generates a second learning model (not illustrated) in advance by learning multiple pieces of teacher data each containing a value indicating an occurrence state of specific sentences meeting the second condition in the multiple sentences for learning and a value indicating a likelihood that a new sentence newly posted on the Internet will turn to disinformation or misinformation. For example, for each of the multiple clusters classified by the cluster classification unit 112, the turning determination unit 115 acquires a value (hereafter, also referred to as a fourth value) output from the second learning model in response to input of a value (hereafter, also referred to as a third value) indicating the occurrence state of specific sentences meeting the second condition in the multiple sentences, as a value indicating a likelihood that a new sentence newly posted on the Internet will turn to disinformation or misinformation.

After that, for example, for each of the multiple clusters classified by the cluster classification unit 112, the turning determination unit 115 calculates a new value (hereafter also referred to as a fifth value) by using both of the value output from the first learning model in response to the input of the value indicating the occurrence state of the specific sentences meeting the first condition and the value output from the second learning model in response to the input of the value indicating the occurrence state of the specific sentences meeting the second condition.

For example, the result output unit 116 outputs the topic associated with a cluster whose likelihood of turning determined by the turning determination unit 115 satisfies the predetermined condition among the multiple clusters classified by the cluster classification unit 112.

For example, the result output unit 116 outputs the topic associated with the cluster for which the new value calculated by the turning determination unit 115 is equal to or greater than a threshold among the multiple clusters classified by the cluster classification unit 112. The weight information 134 will be described later.

[Details of Information Determination Processing in Second Embodiment]

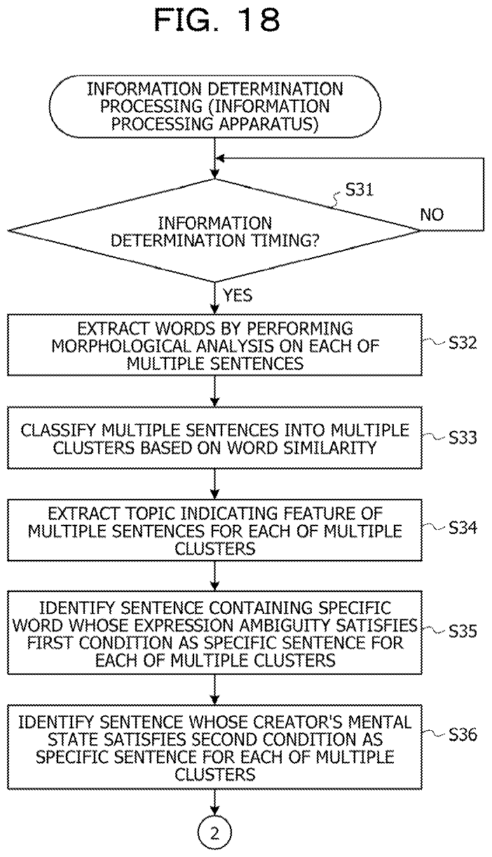

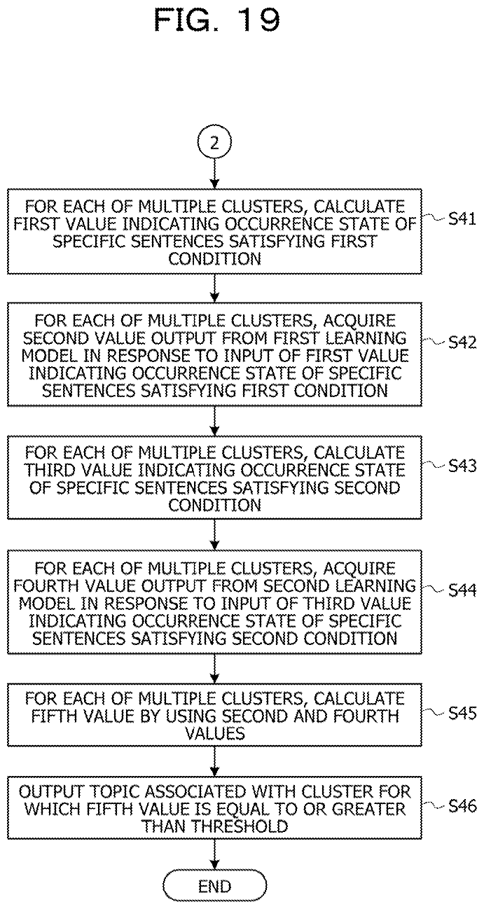

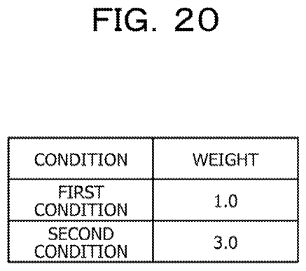

Next, details of the second embodiment will be described. FIGS. 18 and 19 are flowcharts for explaining details of the information determination processing in the second embodiment. FIG. 20 is a diagram for explaining the details of the information determination processing in the second embodiment.

As presented in FIG. 18, the cluster classification unit 112 waits until, for example, an information determination timing comes (NO in S31).

When the information determination timing comes (YES in S31), the cluster classification unit 112 performs morphological analysis on each of multiple sentences contained in the posted information 131 stored in the information storage area 130, and thereby extracts words from each of the sentences (S32), for example.

Subsequently, for example, the cluster classification unit 112 classifies each of the multiple sentences contained in the posted information 131 stored in the information storage area 130 into one of multiple clusters such that sentences having a high similarity between words extracted in the processing at S32 are sorted into the same cluster (S33).

For example, from each of the multiple clusters classified in the processing at S33, the topic extraction unit 113 extracts a topic composed of one or more words indicating a feature of the multiple sentences included in the concerned cluster (S34).

Next, for example, as a specific sentence for each of the multiple clusters classified in the processing at S33, the sentence identification unit 114 identifies each sentence containing a specific word whose expression ambiguity satisfies the first condition among the multiple sentences included in the concerned cluster (S35).

For example, as a specific sentence for each of the multiple clusters classified in the processing at S33, the sentence identification unit 114 identifies each sentence whose creator's mental state satisfies the second condition among the multiple sentences included in the concerned cluster (S36).

After that, as presented in FIG. 19, for example, for each of the multiple clusters classified in the processing at S33, the turning determination unit 115 calculates a value indicating the occurrence state of the specific sentences meeting the first condition in the multiple sentences included in the concerned cluster (S41).

For example, the turning determination unit 115 may calculate the number of occurrences per unit time of the specific sentences meeting the first condition for each of the multiple clusters classified in the processing at S33. For example, the turning determination unit 115 may calculate an increase or decrease rate of the number of occurrences per unit time of the specific sentences meeting the first condition for each of the multiple clusters classified in the processing at S33. For example, the turning determination unit 115 may calculate the occurrence ratio per unit time of the specific sentences meeting the first condition for each of the multiple clusters classified in the processing at S33. For example, the turning determination unit 115 may calculate an increase or decrease rate of the occurrence ratio per unit time of the specific sentences meeting the first condition for each of the multiple clusters classified in the processing at S33.

For example, for each of the multiple clusters classified in the processing at S33, the turning determination unit 115 acquires a value output from the first learning model in response to input of the value calculated in the processing at S41 (S42).

For example, for each of the multiple clusters classified in the processing at S33, the turning determination unit 115 calculates a value indicating the occurrence state of the specific sentences meeting the second condition in the multiple sentences included in the concerned cluster (S43).

For example, the turning determination unit 115 may calculate the number of occurrences per unit time of the specific sentences meeting the second condition for each of the multiple clusters classified in the processing at S33. For example, the turning determination unit 115 may calculate an increase or decrease rate of the number of occurrences per unit time of the specific sentences meeting the second condition for each of the multiple clusters classified in the processing at S33. For example, the turning determination unit 115 may calculate an occurrence ratio per unit time of the specific sentences meeting the second condition for each of the multiple clusters classified in the processing at S33. For example, the turning determination unit 115 may calculate an increase or decrease rate of the occurrence ratio per unit time of the specific sentences meeting the second condition for each of the multiple clusters classified in the processing at S33.

For example, for each of the multiple clusters classified in the processing at S33, the turning determination unit 115 acquires a value output from the second learning model in response to input of the value calculated in the processing at S43 (S44).

For example, the turning determination unit 115 calculates a new value by using the value acquired in the processing at S42 and the value acquired in the processing at S44 for each of the multiple clusters classified in the processing at S33 (S45).

For example, the turning determination unit 115 refers to the weight information 134 stored in the information storage area 130, weights each of the value acquired in the processing at S42 and the value acquired in the processing at S44, and then calculates the total value of the weighted values as the new value. Hereinafter, a specific example of the weight information 134 will be described.

[Specific Example of Weight Information]

FIG. 20 is a diagram for explaining the specific example of the weight information 134.

For example, the weight information 134 presented in FIG. 20 includes items named “Condition” in which each condition is set and “Weight” in which a value for weighting the value indicating the occurrence state of specific sentences satisfying each condition is set.

For example, in the first line of the weight information 134 presented in FIG. 20, “First condition” is set as “Condition” and “1.0” is set as “Weight”. For example, in the second line of the weight information 134 presented in FIG. 20, “Second condition” is set as “Condition” and “3.0” is set as “Weight”.

In this case, for example, the turning determination unit 115 accordingly calculates the new value by summing up a product of the value calculated in the processing at S42 multiplied by “1.0” and a product of the value calculated in the processing at S44 multiplied by “3.0”.

Returning to FIG. 19, for example, the result output unit 116 outputs the topic associated with the cluster for which the value calculated in the processing at S45 is equal to or greater than a predetermined threshold among the multiple clusters classified in the processing at S33 (S46).

In this way, for example, the information processing apparatus 1 is able to change the weight to be used for the specific sentences meeting the first condition and the weight to be used for the specific sentences meeting the second condition in accordance with a feature or the like of the sentences (processing target sentences for the information determination processing) posted on the Internet. Therefore, the information processing apparatus 1 is able to further improve the accuracy of prediction of a topic likely to turn to disinformation or misinformation, for example.

For example, the information processing apparatus 1 (the turning determination unit 115) may generate another learning model in advance in addition to the first learning model and the second learning model. For example, the information processing apparatus 1 (the turning determination unit 115) may perform the processing at S42 and S44, and additionally perform processing of inputting, to the other learning model, a value indicating an occurrence state of specific sentences satisfying a condition other than the first condition and the second condition.

After that, for example, in the processing at S45, the information processing apparatus 1 (the turning determination unit 115) may calculate the new value by using the value output from the first learning model and the value output from the second learning model and additionally using a value output from the other learning model.

For example, the turning determination unit 115 may weight each of the value output from the first learning model, the value output from the second learning model, and the value output from the other learning model by referring to the weight information 134 stored in the information storage area 130, and then calculate the total value of the weighted values as the new value.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing an information determination program causing a computer to execute a process comprising:
classifying a plurality of sentences posted on the Internet into a plurality of clusters based on words contained in the plurality of sentences;
extracting a topic from each of the plurality of clusters, the topic indicating a feature of a plurality of sentences included in the concerned cluster;
for each of the plurality of clusters, determining a likelihood that a sentence about the topic newly posted on the Internet will turn to disinformation or misinformation based on an occurrence state of sentences considered as a factor for generating disinformation or misinformation in the plurality of sentences included in the concerned cluster; and
outputting the topic associated with a cluster, the likelihood of turning of which satisfies a predetermined condition, among the plurality of clusters.

2. The non-transitory computer-readable recording medium according to claim 1, wherein
the plurality of sentences are sentences posted on a social networking service (SNS) for a predetermined period.

3. The non-transitory computer-readable recording medium according to claim 1, wherein
the program further causes the computer to execute a process comprising identifying, for each of the plurality of clusters, a specific sentence as a factor for generating disinformation or misinformation among the plurality of sentences included in the concerned cluster, and
the determining includes, for each of the plurality of clusters, a likelihood that the sentence about the topic newly posted on the Internet will turn to disinformation or misinformation, based on an occurrence state of the specific sentence in the plurality of sentences included in the concerned cluster.

4. The non-transitory computer-readable recording medium according to claim 3, wherein
the identifying includes identifying, as the specific sentence for each of the plurality of clusters, a sentence containing a specific word whose expression ambiguity satisfies a first condition or a sentence whose creator's mental state satisfies a second condition among the plurality of sentences included in the concerned cluster.

5. The non-transitory computer-readable recording medium according to claim 4, wherein
the identifying includes
for each of the plurality of clusters, determining whether or not each of the plurality of sentences included in the concerned cluster contains the specific word by referring to a storage unit that stores word information that specifies the specific word, and
as the specific sentence for each of the plurality of clusters, identifying a sentence determined to contain the specific word among the plurality of sentences included in the concerned cluster.

6. The non-transitory computer-readable recording medium according to claim 4, wherein
the identifying includes
referring to a storage unit that stores state information that specifies mental states of sentence creators and thereby determining, for each of the plurality of clusters, whether or not a mental state of a creator of each of the plurality of sentences included in the concerned cluster is contained in the state information, and
as the specific sentence for each of the plurality of clusters, identifying a sentence whose creator's mental state is determined to be contained in the state information among the plurality of sentences included in the concerned cluster.

7. The non-transitory computer-readable recording medium according to claim 4, wherein
the determining includes acquiring, for each of the plurality of clusters, a value output from a learning model in response to input of a value indicating the occurrence state of the specific sentence in the plurality of sentences included in the concerned cluster, and
the outputting includes outputting the topic associated with a cluster, the value acquired for which is equal to or greater than a threshold among the plurality of clusters.

8. The non-transitory computer-readable recording medium according to claim 7, wherein
the program further causes the computer to execute a process comprising generating the learning model before the determining, by learning a plurality of pieces of teacher data each containing a value indicating the occurrence state of the specific sentence in a plurality of other sentences posted on the Internet and a value indicating a likelihood that a new sentence newly posted on the Internet will turn to disinformation or misinformation.

9. The non-transitory computer-readable recording medium according to claim 7, wherein
the determining includes acquiring, for each of the plurality of clusters, a first value output from a first learning model in response to input of a value indicating the occurrence state of the specific sentence meeting the first condition in the plurality of sentences included in the concerned cluster and a second value output from a second learning model in response to input of a value indicating the occurrence state of the specific sentence meeting the second condition in the plurality of sentences included in the concerned cluster, and
the outputting includes outputting the topic associated with a cluster for which a value calculated from the first value and the second value is equal to or greater than the threshold among the plurality of clusters.

10. The non-transitory computer-readable recording medium according to claim 9, wherein
the outputting includes referring to a storage unit that stores weight information that specifies a first weight for the first value and a second weight for the second value, and outputting the topic associated with a cluster for which a value calculated from the first value, the second value, the first weight, and the second weight is equal to or greater than the threshold among the plurality of clusters.

11. An information determination apparatus comprising:
a memory; and
a processor coupled to the memory and configured to:
classify a plurality of sentences posted on the Internet into a plurality of clusters based on words contained in the plurality of sentences;
extract a topic from each of the plurality of clusters, the topic indicating a feature of a plurality of sentences included in the concerned cluster;
for each of the plurality of clusters, determine a likelihood that a sentence about the topic newly posted on the Internet will turn to disinformation or misinformation based on an occurrence state of sentences considered as a factor for generating disinformation or misinformation in the plurality of sentences included in the concerned cluster; and
output the topic associated with a cluster, the likelihood of turning of which satisfies a predetermined condition, among the plurality of clusters.

12. An information determination method comprising:
classifying a plurality of sentences posted on the Internet into a plurality of clusters based on words contained in the plurality of sentences;
extracting a topic from each of the plurality of clusters, the topic indicating a feature of a plurality of sentences included in the concerned cluster;
for each of the plurality of clusters, determining a likelihood that a sentence about the topic newly posted on the Internet will turn to disinformation or misinformation based on an occurrence state of sentences considered as a factor for generating disinformation or misinformation in the plurality of sentences included in the concerned cluster; and
outputting the topic associated with a cluster, the likelihood of turning of which satisfies a predetermined condition, among the plurality of clusters.
